(19) United States
(12) Patent Application Publication
(10) Pub. No.: US 2017/0043195 A1
(43) Pub. Date: Feb. 16, 2017

(54) FIRE SPRINKLER WATER TERMINATOR

(71) Applicants: CHARLES B. HUGHES, HUNTSVILLE, AL (US); WILLIAM E. PENNEY, HUNTSVILLE, AL (US)

(72) Inventors: CHARLES B. HUGHES, HUNTSVILLE, AL (US); WILLIAM E. PENNEY, HUNTSVILLE, AL (US)

(21) Appl. No.: 14/824,430

(22) Filed: Aug. 12, 2015

(51) Int. Cl. A62C 35/68; A62C 37/12

(52) U.S. Cl. CPC A62C 35/68; A62C 37/12

(57) ABSTRACT

The present invention relates to a fire sprinkler head that once activated can be manually shut off by hand without requiring the flow of water or fire retardant in the feeding pipe to be cut off.

### CROSS-REFERENCE TO RELATED APPLICATIONS

Not applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM

Not applicable.

### STATEMENT REGARDING PRIOR DISCLOSURES BY THE INVENTOR OR JOINT INVENTOR

The inventor did not disclosed the invention herein prior to the 12 month period preceding the filing of this nonprovisional application.

### BACKGROUND OF THE INVENTION

(1) Field of the Invention

The present invention relates to a fire sprinkler manual cutoff mechanism that allows for the quick and easy termination of fire suppressant from a fire sprinkler once a fire has been extinguished and water is no longer needed. This invention allows a user to manipulate a cutoff mechanism located on the fire sprinkler assembly without using any tools. The flow of water suppressant is terminated at the fire sprinkler without any requirement that the fire sprinkler system be deactivated.

(2) Description of Related Art

Fire protection sprinklers are commonly connected to supply pipes installed above the ceilings and behind the walls of a building or room in both commercial and residential settings. These sprinklers typically discharge water to extinguish a fire. Water can be discharged at a rate of 20 to 40 gallons per minute. And, a typical Early Suppression Fast Response (ESFR) sprinkler with a pressure of 50 PSI would discharge approximately 100 gallons per minute. It typically takes five or more minutes for a local fire department to respond to a fire alarm and an additional ten minutes for the responding fire department personnel to set up their equipment to put out a fire. During these fifteen minutes, 300 to 600 gallons can flood the fire site. Once the fire has been suppressed, continued water flow can cause significant damage to both personal property and the building structure flooded with excess water. The damage from the water can exceed the damage caused by the fire. It would be beneficial for firefighters and building support personnel to be able to quickly and easily shut of a fire sprinkler once a fire has been extinguished, and it would be extremely beneficial if the fire sprinklers could be shut off without the necessity of specialized tools which may or may not be on hand during a fire event. In a small fire, shutting off one or two sprinklers is preferable to shutting down the entire sprinkler system. This allows the sprinkler system to be able to reactivate in case of a second fire. And, allows a fire department crew or other building officials to attend to other tasks such as evacuation of the building, providing ventilation for the building, checking for an extension of the fire to other areas, or starting salvage and overhaul operations. Thus, enabling firefighters and appropriate personnel to be able to deactivate one or more fire sprinklers easily and cheaply without the need for special tools will prevent unnecessary water damage following the extinguishing of a fire and assist in recovery efforts.

Currently, several tools are available to disengage individual fire sprinkler heads. These tools include wrenches, gun-shaped devices, and talons. These sprinkler shut off tools are either hand held devices or wrench-shaped tools of less than a foot in length. Each of these tools requires the user to be standing on a chair or other elevated structure to reach the sprinkler head to be deactivated, which is located at a ceiling height of eight feet or more. It can be difficult to operate these shut off tools correctly while standing beneath a stream of water on an elevated surface fully extending one's arms up to the ceiling. These tools are expensive and must be stored in a location readily accessible and the location of each tool must be known to those that may be called upon to deactivate the sprinkler head.

Each of the currently available tools for deactivating a sprinkler head require multiple steps to shut off the head of the sprinkler. If any of these steps is performed incorrectly, then the tool will not disengage the sprinkler head. And, most of these tools must be left engaged with the sprinkler head after use so that one tool can only be used to disengage one sprinkler head until the fire sprinkler system is deactivated. This means that a room containing six sprinkler heads would require six separate shut off tools to stop the flow of water once the sprinkler system was activated. This translates into potentially hundreds of tools needed to shut off a sprinkler system in a typical commercial building. The costs of sprinkler shut off tools and the storage space required to fully protect a commercial building from water damage can be enormous.

Dade (U.S. Pat. No. 7,422, 072 B2) discloses a wedge that deactivates a fire sprinkler when it is inserted into the bracket of a sprinkler head. The point of the wedge is inserted into the bracket and the wedge moved along its length until the width of the wedge prevents further movement. The width of the wedge blocks the flow of fire suppressant from the fire sprinkler. This wedge device must be carefully positioned within the bracket and carefully moved against the force of the discharging fire suppressant. The wedge is difficult to use during a fire event because a typical user may lack the strength to reach up to the ceiling and force an object through a fire sprinkler head with sufficient precision to terminate the flow of water. Additionally, the force of the water streaming from the sprinkler head can deflect a device during its positioning.

Reed (U.S. Pat. No. 6,575,252 B2) discloses a tool for deactivating a sprinkler head. The tool is a hand held device with two engagement surfaces. The engagement surfaces are placed within the bracket of the sprinkler head. The two engagement surfaces are moved away from each other until the engagement surfaces block the flow of water through the sprinkler head. Gallaher (US 2006/0042803 A1) discloses a similar mechanism wherein the movement of levers inserted within a sprinkler bracket press against the orifice of water flow blocking water from flowing through the sprinkler head. The Gallaher (US 2006/0042803 A1) discloses an extension pole to assist the user in reaching the sprinkler head which is at ceiling height. Both of these devices are time consuming and difficult to operate while water is streaming out of the sprinkler head. The user of these two devices is forced to separate the engagement surfaces/levers against the force of the water streaming out of the sprinkler head, which requires a certain amount of strength to be exerted by a user standing several or more feet beneath the activated sprinkler head.

Wilson (U.S. Pat. No. 7,743,838 B2) discloses a lever with rotary motion that shuts off a fire sprinkler head. This device is similar to Reed (U.S. Pat. No. 6,575,252 B2) and Gallaher (US 2006/0042803 A1), except that the means to block the flow of water from the orifice in the sprinkler head is coupled to a fulcrum member comprising a locking mechanism for locking the device in place within the bracket of the sprinkler head. This device is difficult to use because a user must physically move the device into position against the force of water or other fire suppressant rushing from the sprinkler head.

Flynn (U.S. Pat. No. 8,387,712 B2) discloses a fire sprinkler system wherein a fire sprinkler is attached to the fire sprinkler system via a ball valve. The fire sprinkler head can be disengaged by manipulating the ball valve with a wrench-shaped device or screw driver to deactivate a fire sprinkler head. The ball valve is positioned above the sprinkler head. The ball valve has a compression nut that upon being tightened terminates the flow of water from the fire sprinkler head. A wrench having an opening of the proper size is used to tighten the compression nut. It can be time consuming to find a wrench, locate the compression nut on the ball valve, fit the wrench unto the compression nut, and fully tighten the compression nut to terminate the flow of fire suppressant. Because fire sprinkler heads are mounted close to the ceiling, the wrench may repeatedly hit the ceiling during the tightening of the compression nut. This requires the wrench to be rotated and repositioned onto the compression nut numerous times, making the disengagement of the sprinkler head difficult and time consuming. During the time that the user is attempting to install this device onto the compression nut, water flowing from the sprinkler head may be causing significant damage to property below the sprinkler head.

Currently, several “quick connect” sprinkler heads have been disclosed that can be installed quickly and easily. These quick connect devices allow the installation of fire sprinkler heads without the application of glue or tape to seal the connection between the fire sprinkler system and the sprinkler head. But, these devices do not allow for the quick and easy removal of the sprinkler head. And, most importantly, removal of these sprinkler heads while water is charged in the system will result in unrestricted water flow from the sprinkler system causing water damage to property. Craig et al. (U.S. Pat. No. 5,836,397) discloses a fire sprinkler system wherein the sprinkler heads are locked into position by pins located on the sprinkler head that engage slots located on the sprinkler system outlet. Although the sprinkler heads can be quickly installed without additional tools, a specially-designed instrument is required to remove the sprinkler head. On (US 2011/0214886 A1) discloses a quick connect sprinkler head wherein the installer pushes the sprinkler head into the desired located until certain pins bend creating a lock that locks the head into position. Sterm (US 2011/0278026 A1) discloses a sprinkler head with a quick connect coupling wherein insertion of the male member into the bore of the female member forces locking balls to lodge in a grooved portion of the female member. To release the sprinkler head from the sprinkler system, a collar securing the locking balls into the grooved portion of the female member must be moved towards the male member releasing the locking balls and the collar on the sprinkler head must be rotated to release the sprinkler head. Removal of the sprinkler head in each of these prior disclosures does not terminate the flow of water from the sprinkler orifice in this device.

### BRIEF DESCRIPTION OF THE SEVERAL VIEWS OF THE DRAWINGS

FIG. 1 illustrates a side view of the twist valve water terminator fitted with a fire sprinkler head.

FIG. 2 illustrates a side view of the twist valve water terminator connector of FIG. 1.

FIG. 3 depicts a sectional view of the twist valve water terminator connector of FIG. 1.

FIG. 4A is an exploded side view of the valve stem of the twist valve water terminator connector of FIG. 1

FIG. 4B illustrates a side view of the assembled valve stem of the twist valve water terminator connector of FIG. 1.

FIG. 5A is an exploded side view of the half moon flow plate assembly of the twist valve water terminator connector of FIG. 1.

FIG. 5B is atop, side view of the assembled half moon flow plate assembly of the twist valve water terminator connector of FIG. 1.

FIG. 6 is an exploded, side view of the twist valve water terminator connector of FIG. 1.

FIG. 7 is an exploded, side view of the twist valve water terminator connector of FIG. 1 fitted with a fire sprinkler head.

FIG. 8 a sectional view of the twist valve water terminator of FIG. 1 fitted with a fire sprinkler head.

FIG. 9 depicts a view of the flange push valve water terminator connector separated from a fire sprinkler head.

FIG. 10A is an exploded view of the flange push water terminator connector of FIG. 9.

FIG. 10B is an exploded, sectional view of the flange push water terminator connector of FIG. 9.

FIG. 11 is a side view of the push valve water terminator connector of FIG. 9 with an attached bracket separated from a fire sprinkler head.

FIG. 12A depicts a sectional view of push reverse valve water terminator connector separated from the fire sprinkler head.

FIG. 12B illustrates a sectional view of the push valve reverse water terminator connector of FIG. 12A with an attached bracket.

FIG. 13 depicts a side view of the push fire sprinkler head detached from a water outlet.

FIG. 14 is an exploded, sectional view of the push fire sprinkler head embodiment of FIG. 13 detached from a water outlet.

FIG. 15A is a sectional view of the push fire sprinkler head embodiment of FIG. 13 in a closed position that prevents the flow of water or fire suppressant through the fire sprinkler head.

FIG. 15B is a sectional view of the push fire sprinkler head embodiment of FIG. 13 in an open position that allows water to flow through the fire sprinkler head.

FIG. 16A depicts a side view of the push fire sprinkler head connector of FIG. 13.

FIG. 16B illustrates a top view of push fire sprinkler head connector of FIG. 13.

FIG. 16C illustrates a sectional view of the push fire sprinkler head connector of FIG. 13.

FIG. 17A illustrates a top view of the valve stem spacer of the push fire sprinkler head connector of FIG. 13.

FIG. 17B illustrates a side view of the valve stem spacer of the push fire sprinkler head connector of FIG. 13.

FIG. 18 illustrates a side view of the supply valve stem of the push fire sprinkler head connector of FIG. 13.

### DETAILED DESCRIPTION OF THE INVENTION

The invention is described in detail in the following paragraphs with reference to the attached drawings. Throughout this detailed description of the invention, the disclosed embodiments and features are to be considered as examples, rather than being limitations to the invention. Modifications to particular examples within the spirit and scope of the present invention, set forth in the appended claims, will be readily apparent to one of ordinary skill in the art. Further, reference to various embodiments of the disclosed invention does not mean that all claimed embodiments or methods must include every described feature. The various disclosed embodiments and features of the invention may be used separately or together, and in any combination. Terminology used herein is given its ordinary meaning consistent with the exemplary definitions set forth below.

The present invention comprises both a connector that connects a fire sprinkler head to the water supply outlet of a fire sprinkler water supply and a fire sprinkler head. The device can be manipulated by hand or be a tool simulating a hand to terminate the flow of water through the Fire Sprinkler Quick Water Terminator. The present invention utilizes a water terminator valve to terminate the flow of water through a fire sprinkler head. Once the sprinkler system activates and the fire is suppressed, the water terminator can be manipulated by hand to completely and reliably stop the flow of water from a particular sprinkler head without disabling the entire fire suppression system. This allows each fire sprinkler to be quickly and easily disabled, shutting off the flow of water through the fire sprinkler head, and preventing unnecessary water damage. Additionally, this enables the water system to function properly if a second fire breaks out in another area of the building while the water is shut down.

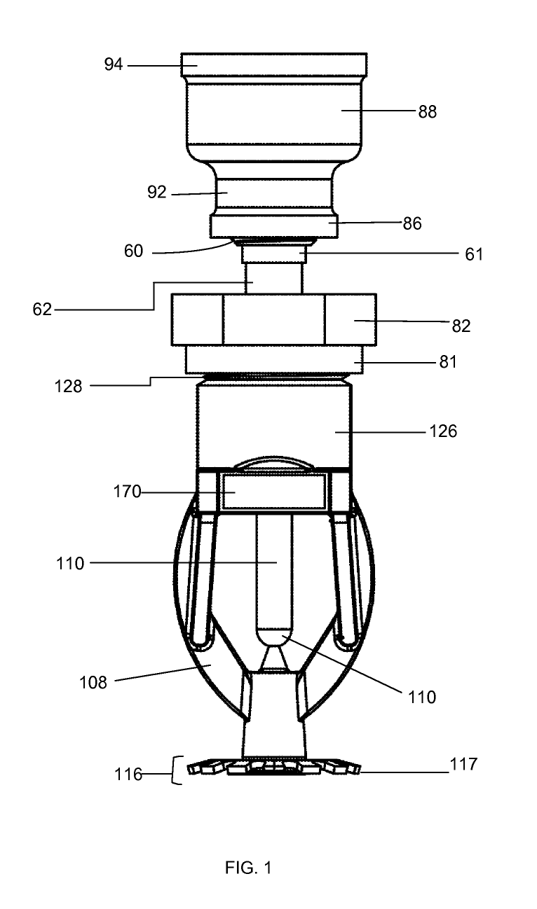

Embodiments of the present invention may include one or more of the following features. In one embodiment of the invention, a twist valve functions as a water terminator valve. The twist valve connects the fire sprinkler head to the water supply line in the ceiling. Once the fire sprinkler head is activated by fire, the water flow through the fire sprinkler head can be terminated by rotating or twisting the fire sprinkler head 180 degrees. The twist valve embodiment of the Fire Sprinkler Water Terminator is illustrated in FIG. 1. The water supply fitting (94, 88, 92, and 86) attaches the twist valve water terminator to the water supply line of the fire sprinkler system. All parts of the present invention, unless otherwise noted, may be composed of steel, brass, PVC, nylon, bronze, cast iron, or any other material or combination of materials suited to provide structural integrity and heat resistance. The water supply fitting is hollow so that water may travel from the water supply line outlet to the fire sprinkler head during a fire event. The water supply fitting comprises a top lip 94 that lies flush with the water supply outlet when the water supply fitting is properly installed. The body 88 of the water supply fitting is grasped during installation to twist the water supply fitting onto the water supply line outlet. The hollow body 88 contains tapered threads 90 (not shown in this figure) lining its cavity. The standard tapered threads 90 thread onto the water supply outlet coupling until the top lip 94 of the water supply fitting is tightly installed onto the water supply outlet. The neck 92 of the water supply fitting connects the body 88 to the bottom lip 86 of the water supply fitting. The neck 92 has a smaller circumference than the body 88. The hollow neck 92 contains tapered threads 162 (shown in FIG. 3) lining its inner cavity. The valve stem ¼″ NPT external tapered threads 60 thread into the tapered threads 162 (shown in FIG. 3) of the water supply fitting, thus, connecting the water supply fitting to the valve stem. The neck 92 connects to the bottom lip 61 of the twist valve stem, which lies flush against the retainer ring 81 when properly installed. The nylon slip ring 80 (shown in FIG. 3) creates a waterproof seal between the water supply fitting neck 92 and the retainer ring 81.

Retainer ring 81 has an hexagon-shaped water coupling 82 that is shaped to permit easy installation using a wrench or similar device. The hollow retainer ring 81 contains a cavity lined with tapered threads 84 (shown in FIG. 3). These tapered threads of the hollow retainer ring 81 are utilized to thread the retainer ring 81 onto the twist valve female housing 126. The hollow retainer ring 81 houses the twist valve stem which controls the flow of water through the fire sprinkler head. The hollow twist valve female housing 126 is a hollow housing that utilizes tapered threads 128 to thread into the retainer ring 81. The sprinkler head frame 170 is threaded or screwed onto the twist valve female housing 126 utilizing internal tapered threads 160 (shown in FIG. 3) that line the internal cavity of the twist valve female housing 126.

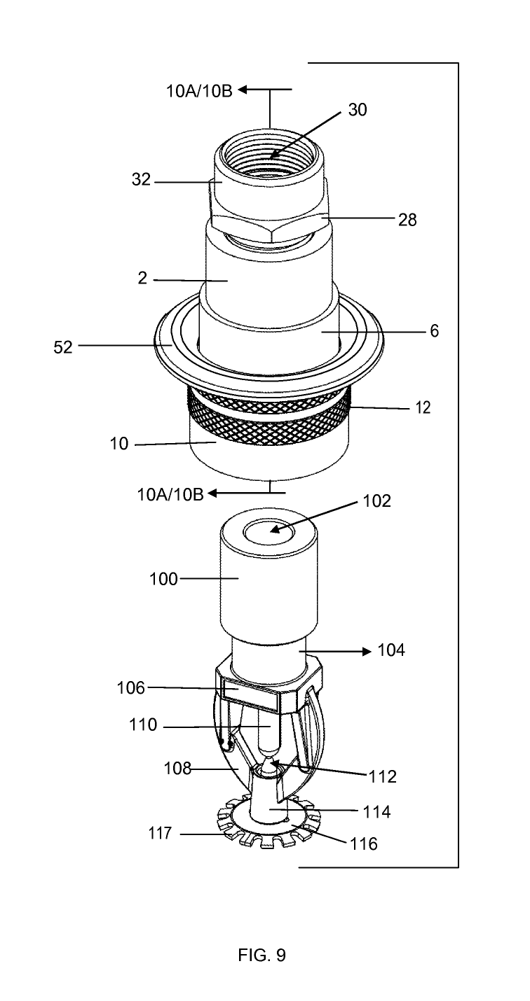

The sprinkler head frame 170 may be a generally cylindrical member having a threadless outer diameter surface and an inner threaded cavity 160 (shown in FIG. 3) that is threaded or screwed into the twist valve female housing 126. The sprinkler head frame 170 may include a central orifice in fluid communication with the twist valve, as will be subsequently described. The sprinkler head frame 170 may include two or more frame arms 108 extending form the sprinkler head frame 170 and may support the deflector 116 at a predetermined distance apart from the sprinkler head frame 170. The frame arms 108 may be substantially rigid members providing structural support for the deflector 116. The frame arms 108 form a protective barrier to prevent damage to the twist valve water terminator upon being struck by an object. The frame arms 108 may also provide a means for a user to manipulate the twist valve to terminate the flow of fire suppressant from the fire sprinkler. The deflector 116 may be a generally circular disk having a plurality of slots, apertures and/or cutouts 117 (shown in FIG. 9). The deflector 116 may be formed to manipulate the flow of alter a trajectory of water or fire suppressant to achieve a desired spray pattern. The deflector 116 can have any suitable shape, size, or pattern of slots, apertures and/or cutouts 117 (shown in FIG. 9) to achieve a desired water or fire suppressant flow pattern.

The glass break bulb 110 is positioned within the twist valve female housing 126 so that the length of the glass break bulb 110 extends away from the twist valve female housing 126 and towards the fire sprinkler head deflector 116. The frame arm(s) 108 join near the deflector 116 forming the apex 114 of the fire sprinkler head. The apex 114 encircles the brass break pin 120 and provides for the attachment of the deflector 116.

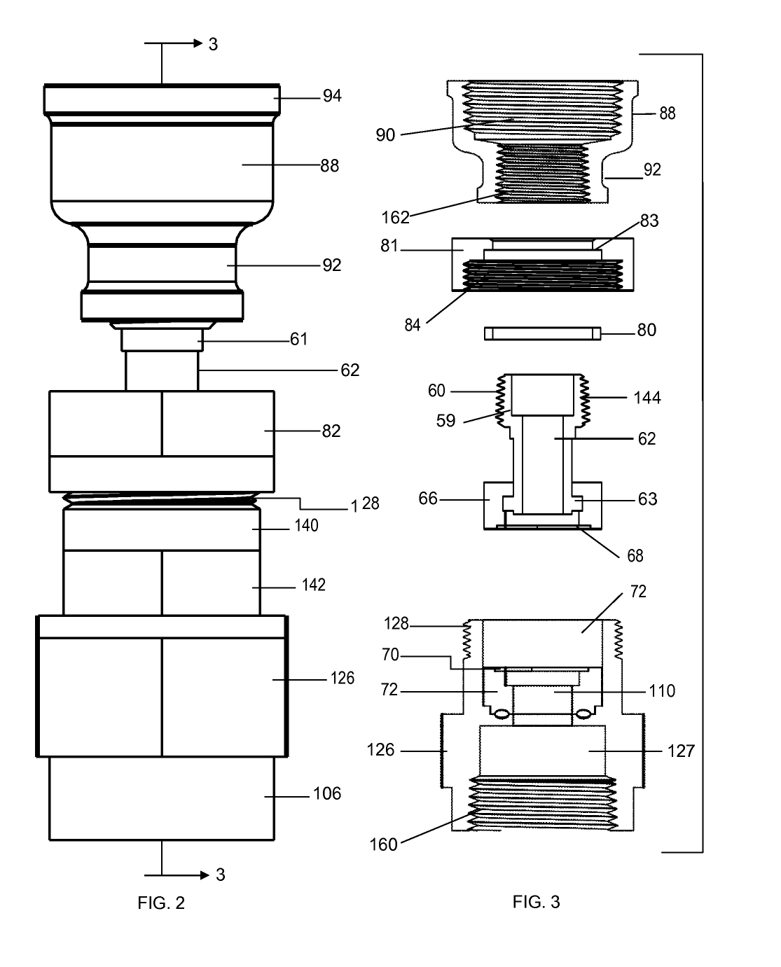

A side view of the twist valve water terminator connector of FIG. 1 without a fire sprinkler head attached is illustrated in FIG. 2. FIG. 3 is an exploded sectional view of the twist valve water terminator connector depicted in FIG. 2. The top lip 94 and the body 88 of the water supply fitting are hollow with ½″ NPT (National Pipe Thread Taper) internal tapered threads 90. The ½″ tapered threads 90 thread or screw onto the fire sprinkler system water supply outlet attaching the twist valve disconnect device to the water outlet. The hollow neck 92 and the bottom lip 86 of the water supply comprise ¼″ NPT internal tapered threads 162. The ¼″ NPT internal tapered threads 162 are utilized to thread or screw onto the valve stem threads 60. The retainer ring 81 is a hollow fitting with a cavity to secure the nylon washer 80 against the neck of the water supply fitting 92 forming a waterproof seal. The retainer ring 81 encloses the top portion of the twist valve: including the twist valve head 59 that contains ¼″ external NPT tapered threads 61, the valve stem neck 61, and the valve stem 62. ¾″ NPT fine tapered threads 84 line the inner cavity of the retainer ring 81. The tapered threads 84 are utilized to thread or screw the retainer ring 81 onto the twist valve female housing 126. The retainer ring 81 may include a hexagon-shaped water coupling 82 to facilitate installation with a standard wrench. The twist valve comprises: the stem valve head 59, which is a hollow member with tapered threads 60 covering its external surface, the hollow stem 62 that connects the stem valve head 59 to the stem valve base 63, the stem valve base 63 that anchors the flow plate retainer 66, and the flow plate 68 which caps the flow plate retainer 66. The twist valve female housing 126 is a hollow member with ½″ NPT tapered threads on the external surface that threads or screws into the ¾″ fine thread NPT internal tapered threads of the retainer ring 84. The hollow cavity of the twist valve female housing 126 houses the half moon flow plate retainer 72 and the half moon flow plate 70. The glass break bulb 110 is positioned against the half moon flow plate 70 in FIG. 3. The twist valve female housing 126 contains an internal cavity 127 for water to pass during a fire event. The internal cavity 127 has ½″ NPT tapered threads 160 to thread or screw the fire sprinkler head into position.

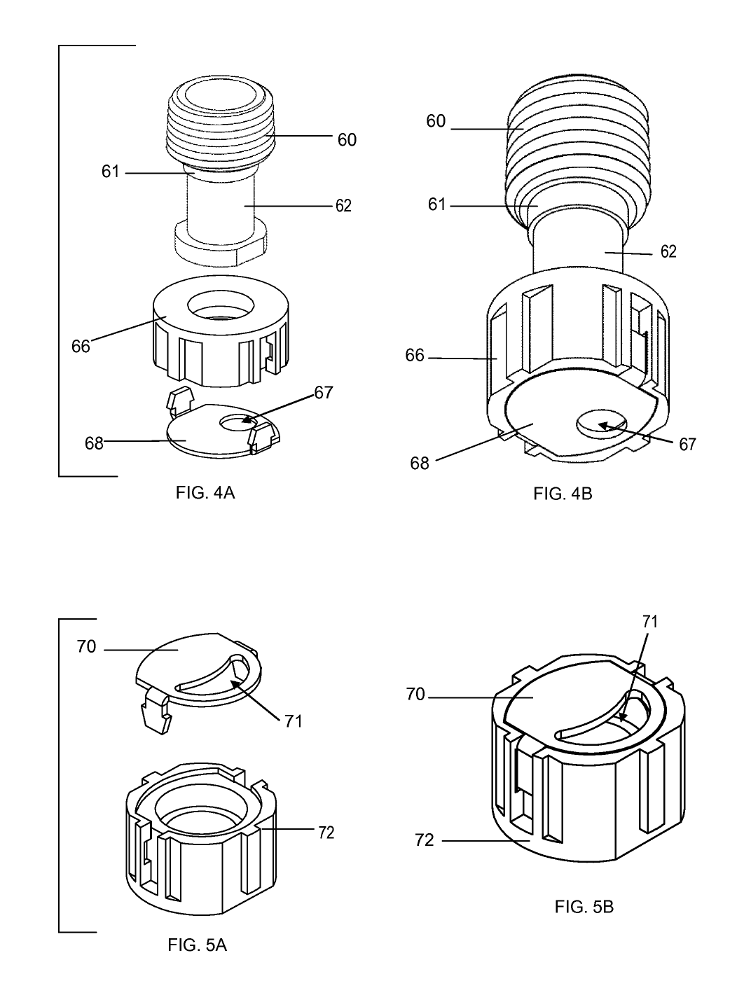

FIGS. 4A and 4B depict the twist valve stem. FIG. 4A is an exploded view of the twist valve stem and FIG. 4B depicts the assembled twist valve stem. The twist valve stem (60, 61, and 62) is composed of metal. But, the twist valve flow plate retainer 66 and the twist valve flow plate 68 may be plastic, PVC, or other substance molded onto the twist valve base. The flow plate 68 has an opening 67 that permits water to flow to the fire sprinkler head assembly'. Fire suppressant flows through opening 67 during a fire event. FIGS. 5A and 5B depict side views of the flow plate assembly. FIG. 5A is an exploded side view of the half moon flow plate assembly of the twist valve water terminator and FIG. 5B is a top, side view of the assembled half moon flow plate assembly. Both the half moon flow plate retainer 72 and the half moon flow plate 70 are molded plastic, PVC, or other suitable substance. The half moon flow plate 70 contains a half-moon shaped opening 71 that traverses the flow plate and permits water or other fire suppressant to flow through the twist valve water terminator and out the fire sprinkler head during a fire event. The half moon flow plate assembly nests within the female housing 126 (shown in FIG. 3) so that the half moon flow plate 70 is in direct contact with the twist valve flow plate 68. During a fire event, the opening in the half moon flow plate 70 is aligned so that the twist valve flow plate opening 67 is in contact with the half moon flow plate opening 71 creating a channel for water or fire retardant to flow during a fire event. When the fire is suppressed, a user rotates the fire sprinkler head 180° which causes the half moon flow plate retainer 72 to pivot 180°, which causes the position of the half moon flow plate opening 71 to rotate away from the twist valve flow plate opening 67. The 180° rotation of the fire sprinkler head immediately stops the flow of water of fire suppressant through the twist valve flow plate opening 67, which stops the flow of water through the fire sprinkler head. This allows a user or fire department personnel to disable a fire sprinkler head when the fire is extinguished so that water damage is minimized without shutting off the flow of fire suppressant to the entire fire sprinkler system.

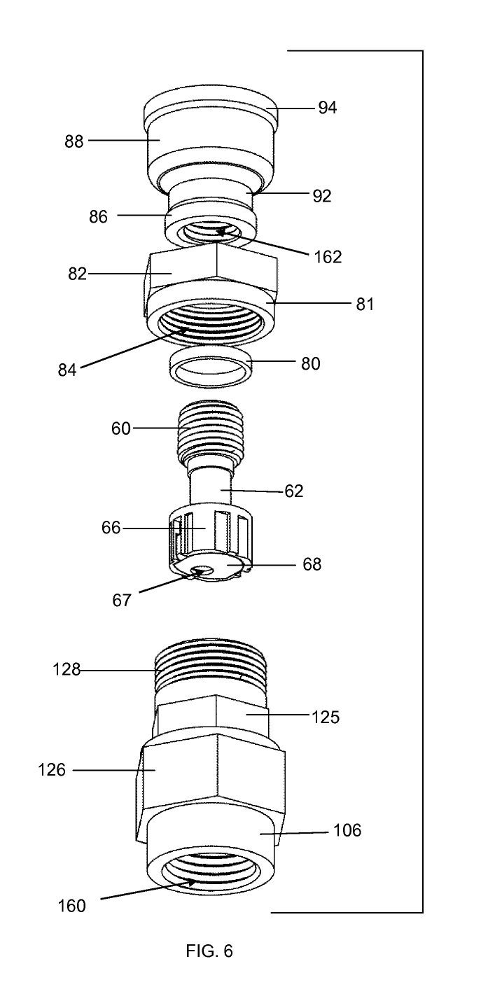

An exploded view of the twist valve water terminator connector is shown in FIG. 6. The water supply fitting (94, 88, 92, 86, and 162) is threaded securely onto the water sprinkler system outlet until the water supply fitting lip 94 is flush against the water sprinkler system outlet, preferably flush against the ceiling of the room wherein the fire sprinkler head is located. The retainer ring (82, 81, and 84) fits over the neck 92 of the water supply fitting. The nylon ring 80 creates a waterproof seal between the water supply fitting neck 92 and the retainer ring. The twist valve head 59 (shown in FIG. 3) containing tapered threads 60 and twist valve stem 62 are positioned within retainer ring 81. Both twist valve flow plate retainer 66 and twist valve flow plate 68 are positioned within the cavity of the twist valve female housing 126. The twist valve female housing 126 contains ½″ NPT external tapered threads 128 that thread or screw into the retainer ring 81 fine tapered threads 84. The twist valve female housing comprises two hexagon-shaped water couplings 125 and 126 that can be used to mechanically install the twist valve female housing onto retainer ring 81. The internal cavity of the twist valve female housing attaches to the fire sprinkler head using ½″ NPT tapered threads 160 (shown in FIG. 3). The external surface of the twist valve female housing has a smooth surface 106 on which to position the fire sprinkler head frame 170.

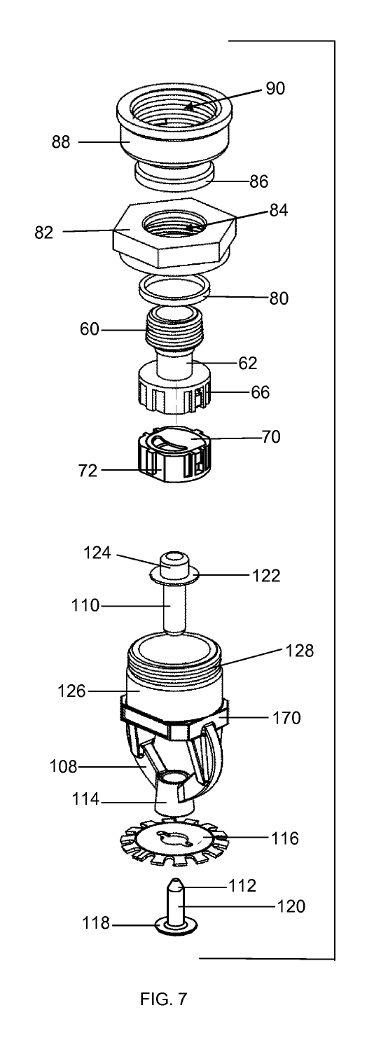

An exploded, side view of the twist valve water terminator connector is shown in FIG. 7 aligned with a fire sprinkler head assembly. The half moon retainer 72 and half moon flow plate 70 are shown aligned with the twist valve flow plate retainer 66. The glass break bulb 110 is shown above the twist valve female housing 126. The glass break bulb 110 has a brass circular brim 122 that protrudes from the glass break bulb 110 and positions the glass break bulb 110 into position within the fire sprinkler head assembly. The brass glass break bulb pin top 124 is shaped ensures that the glass break bulb 110 is positioned within the half moon retainer 72. FIG. 7 shows the fire sprinkler head frame threaded or screwed into the ½″ NPT tapered threads 160. The fire sprinkler head assembly contains two or more arms 108 that project from the fire sprinkler head frame 170 to the apex 114 of the fire sprinkler head. The deflector 116 is positioned against the apex 114.

The glass bulb break pin (112, 120, and 118) is made from brass, steel, iron, or a suitable metal or metal combination that provides sufficient strength and heat resistance to permit it to retain its shape with an increase in temperature. The pointed break tip 112 is sharp enough to penetrate the glass break bulb 110. The glass break bulb 110 is a hollow piece of glass with a small glass reservoir that holds a heat-sensitive liquid. The heat-sensitive liquid may be mercury, alcohol, or glycerin, or any other liquid that expands when heated. When the liquid is heated to a sufficient temperature, the expansion of the liquid causes the glass break bulb 110 to expand, pressing against pointed tip 112 of the brass break pin 120. The sharp, pointed tip 112 causes the glass break bulb 110 to break when it expands. Breakage of the glass break bulb 110 permits water or fire suppressant to flow through the twist valve water terminator and out of the fire sprinkler onto the fire below. The stem of the glass bulb break pin 120 is the length of the apex 114 and is secured into the apex 114 via its circular base 118, which anchors the deflector 116 into the apex 114.

Although a glass bulb sprinkler head is shown in the figures, a fused link sprinkler head may be utilized with the twist valve water terminator fire connector. A fusible sprinkler head has a two-part metal element that is fused together with a heat-sensitive alloy. The fusible link holds a plug into place within the fire sprinkler head until the ambient temperature around the sprinkler head reaches a sufficient temperature. When the temperature of the ambient air around the fire sprinkler head reaches a predetermined value, the alloy releases the metal elements allowing them to separate, which causes the plug to be released, and water to be released from the fire sprinkler head.

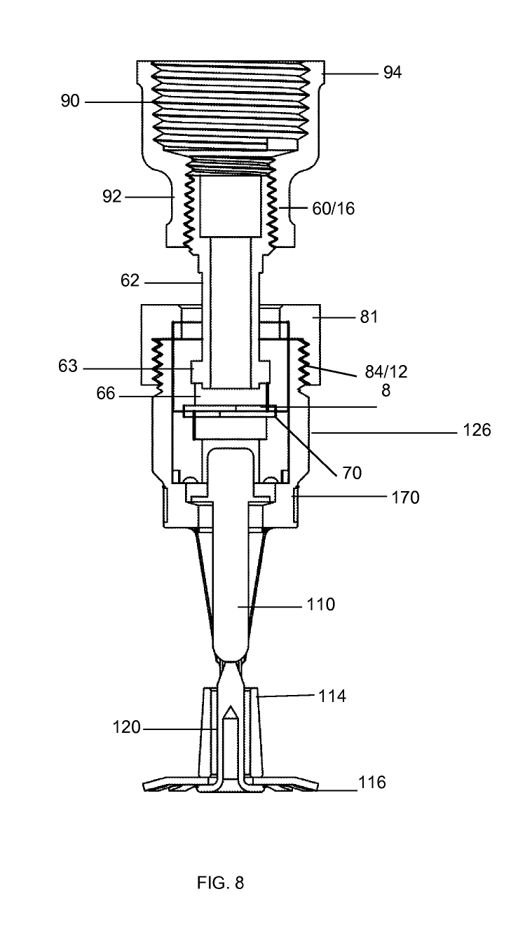

FIG. 8 illustrates a cross sectional view of the twist valve water terminator connector fitted with the fire sprinkler head. A hollow cavity runs the length of the twist valve disconnect connector from the water supply fitting lip 94 to the twist valve female housing 126. The external ¼″ NPT tapered threads 60 of the twist valve stem are threaded into the internal ¼″ NPT tapered threads 162 of the water supply fitting hollow neck 92. The internal tapered threads of the retainer ring 84 are secured to the external tapered threads 128 of the twist valve female housing 126. The twist valve stem base 63 secures the twist valve flow plate retainer 66 into position. The twist valve flow plate 68 is flush with the half moon flow plate 70. The glass break bulb 110 is secured into the twist valve female housing by the glass break bulb brim 122.

The glass break bulb 110 is in contact with the break tip 112 (shown in FIG. 7) of the brass break pin 120. The apex 114 of the frame assembly encircles the brass break pin 120 preventing accidental breakage of the glass break bulb 110. A fused link sprinkler head may be utilized instead of the glass break bulb 110 embodiment.

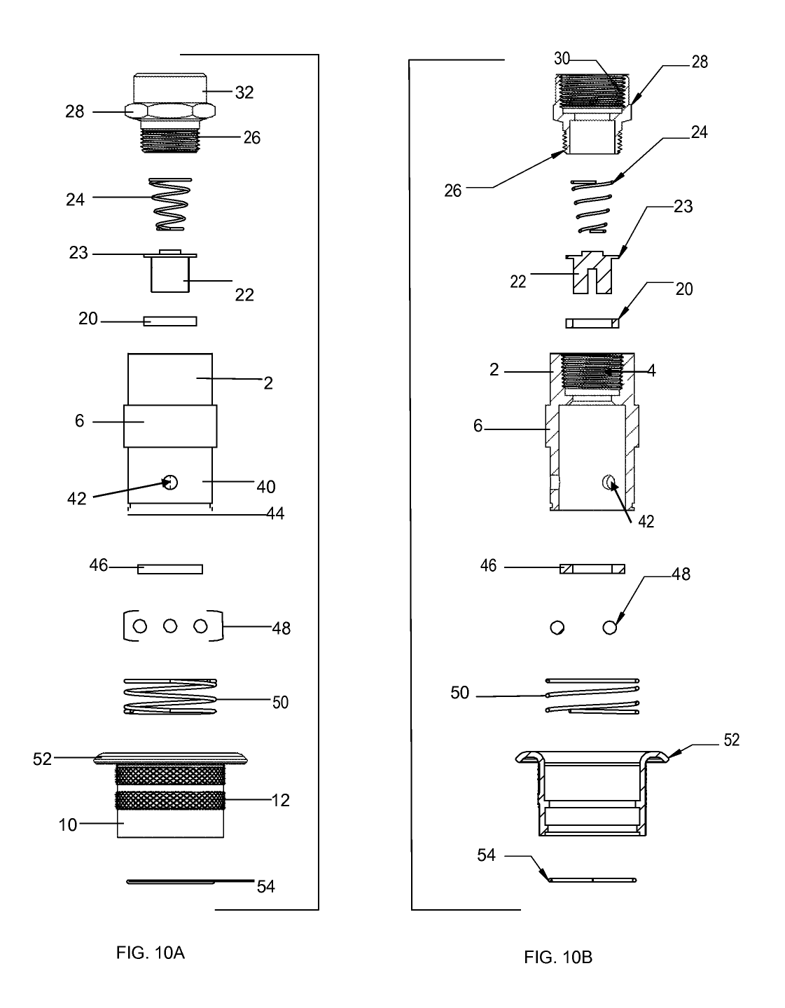

A second embodiment of the invention is the flange push water terminator connector and fire sprinkler head assembly. This embodiment is shown in FIGS. 9, 10A and 10B. The flange push water terminator connector has an arm member or flange that terminates the flow of water or fire suppressant through the fire sprinkler head when a user pushes it upwardedly. A user pushes up on the flange, arm, protrusion, know, extension or brim causing the fire sprinkler head to be released from the flange push water terminator connector and drop to the floor. When the fire sprinkler head is released from the push disconnect connector, the water or fire suppressant flow ceases. The flange or arm member may be of any shape or length that facilitates the quick release of the fire sprinkler head. The flange may hang down below the fire sprinkler head or may protrude out from the fire sprinkler head. The flange may be composed of brass, steel, PVC, bronze, cast iron, or any other material or combination of materials suited to provide structural integrity and heat resistance.

FIG. 9 depicts the flange push water terminator connector separated from the fire sprinkler head assembly. The flange push disconnect connector includes the following parts: the water supply fitting 32 that contains standard internal ½″ NPT tapered threads 30 that thread or screw onto the water sprinkler supply outlet, a hexagon-shaped water coupling 28 to enable an installer to use a standard wrench to install the connector, the push water terminator upper housing 2, push water terminator lower housing 6, the release flange 52, and push water terminator release collar 10 that may include one or more etched grooves 12 on the external surface of the release collar 10. The etched grooves 12 enable a user to grab the release collar 10 by holding onto the etched grooves 12 and pulling down on said release collar 10 to cause the fire sprinkler head assembly to be discharged from the release collar 10 and the push valve to block the flow of fire suppressant. The fire sprinkler head assemble includes the following parts: male water terminator 100 which includes hollow cavity 102 that channels water through the fire sprinkler head assembly, the sprinkler housing connector 104 that connects the fire sprinkler male water terminator 100 to the sprinkler head frame 106, two or more frame arms 108 that extend from the sprinkler head frame 106 to the apex 114 forming an enclosure to protect the glass break bulb 110 from accidental damage, the glass break pin tip 112 of the glass break pin 120, and the deflector 116 that may be formed with fingers 117 stemming from the deflector 116 to cause the water or fire suppressant released from the sprinkler head assembly to stream in a desired pattern. The glass break bulb may be filed with any heat-sensitive liquid. Heat-sensitive liquids such as alcohol, glycerin and mercury expand upon heating. When subjected to a fire event the ambient temperature surrounding the fire sprinkler head will rise, a bubble within the heat-sensitive liquid will expand breaking the glass break bulb 110 when the glass break bulb 110 pushes on the brass break pin 120, causing tip 112 of the brass break pin 120 to press into glass break bulb 110 breaking said bulb 110, which causes water or fire suppressant to flow from the fire sprinkler head assembly. Once the fire is extinguished, the fire sprinkler head may be shut off my simply pushing up on the push water terminator flange 52, which releases the fire sprinkler head from the push water terminator connector and terminates the flow of water or fire suppressant to the fire sprinkler assembly.

Each of the embodiments disclosed herein, including the flange push water terminator connector, may be used with a fusible link fire sprinkler head instead of a glass bulb fire sprinkler head. Embodiments utilizing a fusible link fire sprinkler head will comprise the connector disclosed herein with a fuse-linked fire sprinkler head modified to contain all of the qualities and attributes of the bulb fire sprinkler head.

An external, side view of the flange push water terminator connector is depicted in FIG. 10A. All parts comprising the flange push disconnect connector, except for rubber washers 20 and 46, may be formed from brass, stainless steel, bronze, cast iron, or any other material or combination of materials suited to provide structural integrity, corrosion resistance and heat resistance. The water supply fitting 32 contains internal ½″ NPT tapered threads 26 that thread or screw onto the fire sprinkler system supply outlet. The water supply coupling 28 is utilized to install the connector with a standard wrench. The water supply fitting 32 contains ½″ NPT external tapered threads that are used to connect the push water terminator upper housing 2 to the water supply fitting 32. The seal plug 22 contains both a top member 23 with a circular protrusion that pushes against the water supply fitting 32 and a seal plug spring 24 that provides spring tension to the push water terminator connector. Rubber washer 20 forms a waterproof seal around the seal plug 22. The external taper threads 26 thread or screw into the push water terminator upper housing 2 to completely enclose the seal plug 22, seal plug spring 24, and rubber washer 20 within the push water terminator upper housing 2.

The upper housing 2 of the flange push water terminator connects to the lower housing 6 of the push water terminator connector. The lower housing 6 creates a stable surface to push the release flange 52 against to terminate the flow of fire suppressant through the fire sprinkler head assembly. The body 40 of the push water terminator housing contains one or more circular openings 42. Each circular opening 42 may hold one ball bearing 48. This embodiment includes three ball bearings 48. Rubber washer 46 lies flush with the lower housing member 6 providing a waterproof seal to prevent water or fire suppressant from leaking from the connector. The body 40 includes a notch 44 encircling the body 40 that is sized to retain a wire retainer clip 54. The wire retainer clip 54 locks the release flange 52 onto the body 40 of the push water terminator housing when the wire retainer clip 54 is positioned correctly in the notch 44. Tension spring 50 fits within the body 40 providing spring tension. The release flange 52 extends outward from the release collar 10. The fire sprinkler male disconnect 100 (shown in FIG. 9) is inserted into the release collar 10 when the release collar 10 is pushed up towards the water supply outlet. When the release collar 10 is released, the springs force it to move toward the male disconnect 100 (shown in FIG. 9) allowing the ball bearings 48 to clamp onto the male disconnect member 100 (shown in FIG. 9) securing the fire sprinkler assembly into position for use during a fire event. Once a fire has been extinguished, a user or fire department personnel can quickly terminate the flow of water or fire suppressant from the push water terminator connector by pushing upwards on the release flange 52 towards the ceiling until the release flange 52 makes contact with the lower housing 6. Pushing up on the release flange 52 causes the ball bearings 48 to be released from the circular openings 42 located on the body 40, which releases the male disconnect 100 (shown in FIG. 9) of the fire sprinkler assembly from the push water terminator connector. When the male connector 100 (shown in FIG. 9) is disconnected from the push water terminator connector, water or fire retardant can not flow from the water supply outlet because the seal plug 22 blocks the flow of water or other fluid out of the device.

FIG. 10B is an exploded, cross sectional view of the flange push water terminator connector. A channel for water or fire suppressant to travel through the connector and out the fire sprinkler head is shown. Internal ½″ NPT tapered threads 30 line the inner cavity of the water supply fitting 32. The inner threads 30 secure the device to the water supply outlet. External ½″ NPT tapered threads connect the water supply fitting 32 to the ½″ NPT internal tapered threads 4 of the upper housing 2 of the push water terminator housing enclosing the seal plug 22, seal plug spring 24, and rubber washer 20. The ball bearings 48, rubber washer 46, and tension spring 50 are secured within the body 40 and the release collar 10 when the wire retainer clip 54 is secured within the circular depression 44 located on the body 40.

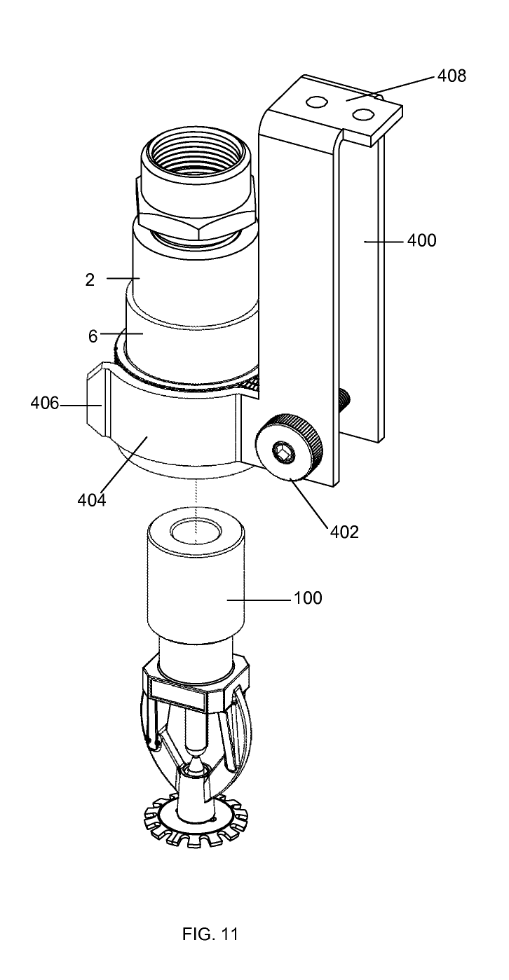

FIG. 11 depicts a side view of the flange push valve water terminator connector with an attached bracket. The flange 52 has been removed from the connector so that the bracket clamps 404 may be securely attached. The fire sprinkler head is shown separated from the flange push valve water terminator connector. The embodiment shown in FIG. 11 is the embodiment shown in FIGS. 9, 10A, and 10B with the addition of a bracket (400, 402, 404, 406, and 408) that has been added to prevent the release collar 10 from moving relative to the body 40 of the connector. When the bracket (400, 402, 404, 406, and 408) is engaged about the collar 10, a user pushes up on the fire sprinkler head, the body 40 (previously shown) moves relative to the collar 10, pushing on tension spring 50 (previously shown), releasing the ball bearings 48 (previously shown) from the circular openings 42 (previously shown), releasing the fire sprinkler male disconnect 100 from the connector while terminating the flow of water or fire suppressant through the fire sprinkler head.

The bracket (400, 402, 404, 406, and 408) comprises a connector plate 408 that is used to secure the bracket to an overhead ceiling or to another support structure located above the push valve water terminator device, two arms 400 that stem drown from the connector plate 408 to the bracket clamps 404, two thumb tabs 406 that allow the bracket to be manually released from the collar 10, and a anchoring pin 402 that secures the two bracket clamps 404 into a locked position about the collar 10. The bracket may be composed of any suitable material that provides strength to the bracket so that it can secure the collar 10 preventing the collar 10 from moving relative to the fire sprinkler male disconnect 100 when the fire sprinkler male disconnect 100 has force exerted upon it by a user. The connector plate 408 may be fixed mounted to a rigid mount, such as a sheetrock ceiling, a wooden stud, a metal beam or interior of a recessed enclosure or the like. In order to utilize this bracket, the water supply outlet must be able to move approximately 3.175 mm upward with the movement of the male sprinkler disconnect 100. If the water supply outlet pipes are rigidly held into position when the push valve water terminator connector is installed, the water supply outlet pipes may be loosened sufficiently to allow the necessary 3.175 mm movement by placing a screwdriver or other prying instrument between the brackets securing the water supply outlet and prying the bracket so that it is provides the necessary movement.

In other embodiments, a bracket with one or more prongs that secure the push quick disconnect upper housing 2 and or the lower housing member 6 may be employed to prevent movement of the push valve water terminator connector.

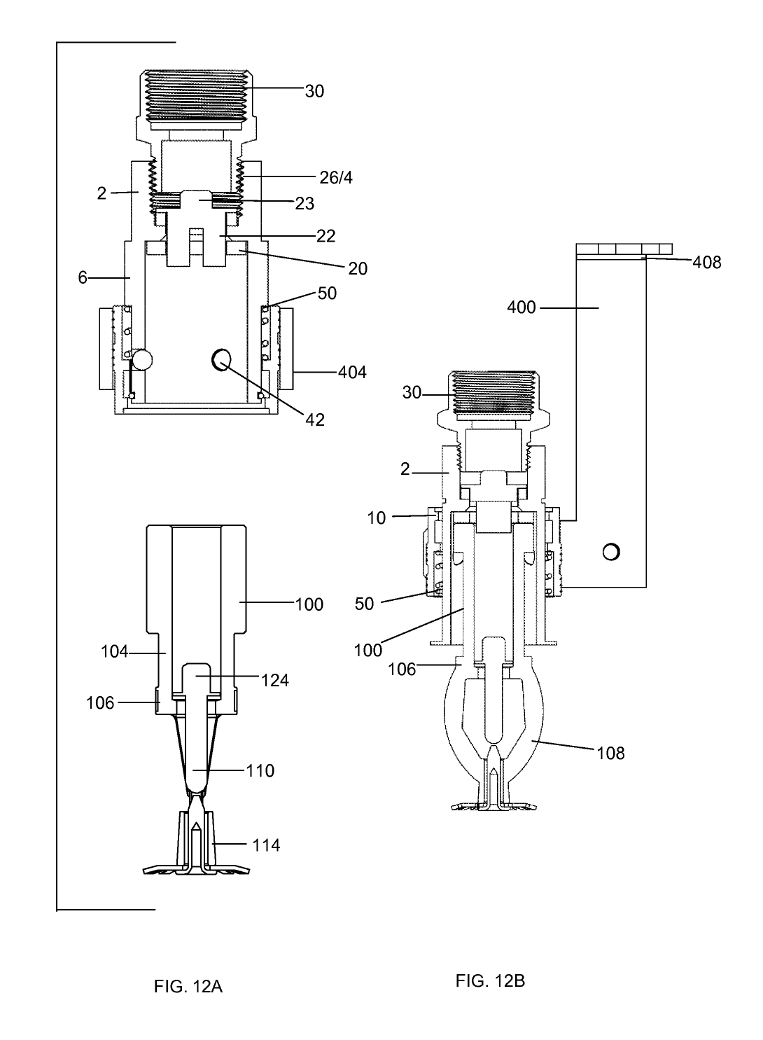

In yet another embodiment, shown in FIGS. 12A and 12B, a quick disconnect connector wherein collar 10 is held by bracket clamps 404, or the like as previously disclosed, except that the collar is configured so that it is movable upward toward the water supply in order to release the male sprinkler disconnect 100, as previously described. This embodiment also relies on either existing play in the plumbing pipes feeding the fire sprinklers, or such play may be induced by prying on the plumbing clamps holding the water sprinkler system to loosen them a bit until the required amount of play is developed. Here, the amount of play needed to release the fire sprinkler male disconnect 100 is approximately 1.58 mm. With this construction, when the fire sprinkler male disconnect 100 is pulled downward against the bias of tension spring 50 (previously shown), the collar 10 is held stationary by the bracket clamps 404 while the upper housing 2 and the lower housing member 6 move downward approximately 1.58 mm to release the fire sprinkler male disconnect 100 and terminate the flow of water through the deflector 116.

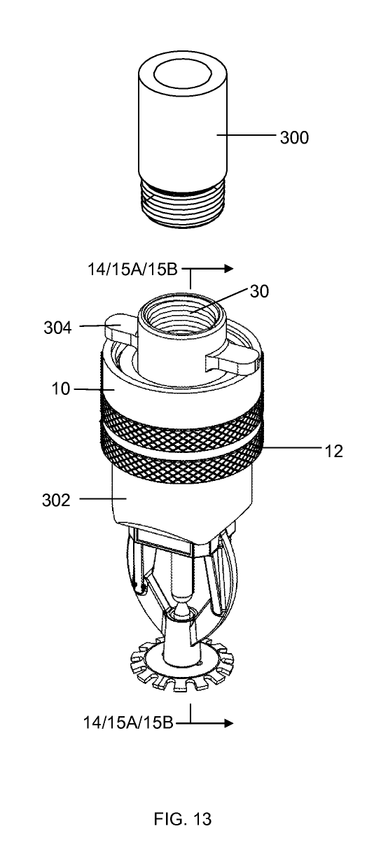

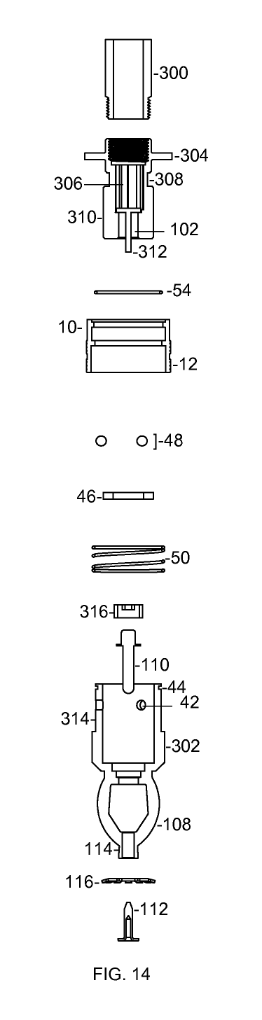

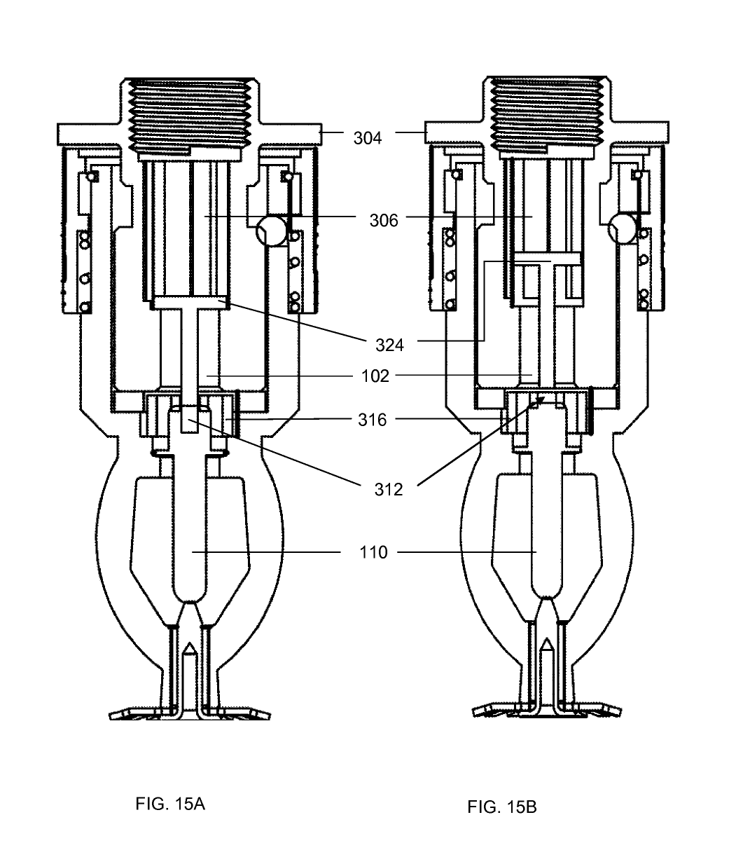

FIG. 13 depicts a side view of a push fire sprinkler head water terminator device positioned beneath a water supply outlet. The water supply outlet 300 supplies water to the water terminator connector. The push fire sprinkler head embodiment is attached to the water supply outlet 300 via ½″ NPT tapered threads 30. One or more collar stops 304 are positioned on the outside of the water supply fitting 32. Once a fire is extinguished, a user pushes the push fire sprinkler body 302 upward, which pushes the collar 10 against the collar stop(s) 304. The push fire sprinkler upper body 314 is then released from the connector body 310 (shown in FIG. 14) terminating the flow of water or fire suppressant from the connector. FIG. 14 shows a sectional, exploded view of this embodiment. FIG. 15A shows a sectional view of this embodiment in a ready position while the connector is charged with water, and FIG. 15B shows a sectional view of this embodiment in a discharge position with water being discharged from the push fire sprinkler head.

FIG. 14 depicts an exploded, sectional view of the push fire sprinkler head embodiment. The connector is comprised of the following: one or more collar stops 304, neck 308 that connects the water outlet fitting 32 to the connector body 310, a central cavity lined with grooves 306, a smooth channel 102 that has a smaller diameter than the grooved cavity 306, and the valve supply stem 312 and 324. The connector is screwed onto the water supply outlet 300, and remains attached to the water supply outlet 300 when the push fire sprinkler head is disengaged and water flow is terminated. Water or fire suppressant flows through the grooved channel 306 and smooth channel 102 to the push fire sprinkler head upper body 314 during a fire event. The push fire sprinkler head comprises the following parts: wire retainer clip 54, collar 10 with etched grooves 12 to facilitate grasping by a hand, one or more ball bearings 48, rubber washer 46 that creates a water proof seal between the connector and the fire sprinkler head, tension spring 50, valve stem spacer 316, glass break bulb 110, push fire sprinkler head upper body 314 with notch 44 that the wire retainer clip 54 nests into, push fire sprinkler head lower body 302, frame arms 108, apex 114, deflector 116, and brass break pin 112. The fire sprinkler head lower body 302 extends outward from the fire sprinkler head upper body 314 creating a lip for the collar 10 to rest upon. The lower body 302 of the fire sprinkler head contains a hollow cavity to house the glass break bulb 110 and the valve stem spacer 316. The exterior of the fire sprinkler head upper body 314 is encircled by tension spring 50, which is encased by collar 10. The fire sprinkler head upper body 314 contains one or more circular openings 42 that house a single ball bearing 48 when the fire sprinkler head upper body 314 is locked into the connector body 310. The tension spring 50 forces the ball bearing(s) 48 into the opening 42. When the push fire sprinkler head is pushed upward against the collar stop(s) 304, the tension spring 50 becomes compacted, which shortens the width of the tension spring 50 and allows the ball bearing(s) 48 to be released from the opening(s) 42, which releases the fire sprinkler head upper body 314 from the connector body 310 and terminates the flow of water or fire suppressant through the device. The collar 10 is secured onto the fire sprinkler head upper body 314 by the wire retainer clip 54, which is placed within notch 44. Both the fire sprinkler head upper body 314 and the fire sprinkler head lower body 302 are hollow to allow water or fire suppressant to flow to the push fire sprinkler head.

The push fire sprinkler head embodiment is shown in a ready position in FIG. 15A. In the ready position, the device is ready to discharge water upon the development of a fire event. In the ready position, the connector is charged with water, but the water is not flowing through the push fire sprinkler head. The supply valve stem pin 312 and valve stem head 324 are joined so that they form a “T” when viewed from the side. The supply valve stem head 324 is positioned flat against the bottom of the grooved chamber 306 of the connector body 310 in the ready position. The bottom of the supply valve stem pin 312 is positioned within a central opening 322 (shown in FIG. 17B) of the valve stem spacer 316 in the ready position. Once a fire event occurs, the push fire sprinkler head discharges water. FIG. 15B shows the device in the position wherein water or fire suppressant is being discharged. When a fire causes the ambient temperature to rise surrounding the push fire sprinkler head, the glass break bulb 110 breaks, causing the supply valve stem pin 312 and head 324 to move into the grooved cavity 306 of the connector. This movement allows water or fire suppressant to move through the channels lining the inside of the grooved cavity 306, and through the push fire sprinkler head until it is deflected by the deflector 116 onto the fire beneath. When a user pushes up on the push fire sprinkler head lower body 302 disengaging the head, the supply valve stem head 324 is forced downward against the bottom of the grooved cavity 306 of the connector body 310 by the force of the flow of water or fire suppressant. The force of the supply valve stem head 324 pushing against the connector body 310 creates a plug that terminates the flow of water or fire suppressant from the connector.

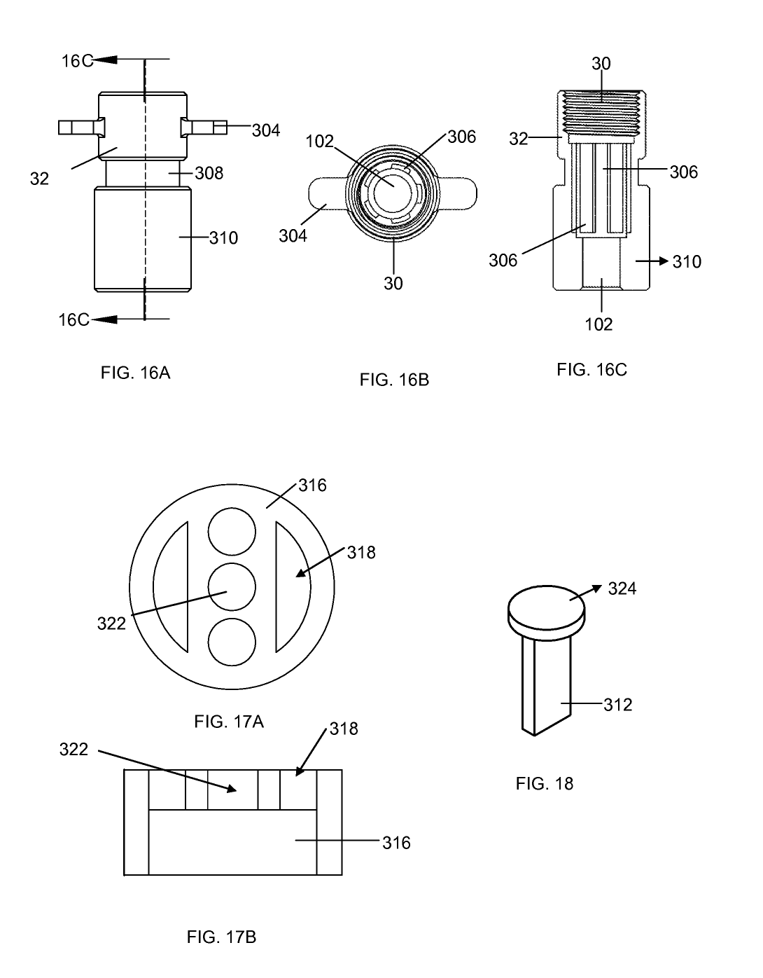

FIGS. 16A, 16B, and 16C depict the push fire sprinkler head connector in a side view, a top view looking down from the tapered threads 30 of the water supply fitting 32 (shown in FIG. 16A) to the smooth channel 102, and a sectional view of the connector, respectively. The side view depicted in FIG. 16A illustrates the water supply fitting 32 with two collar stops 304 projecting outwardly that are connected to the connector body 310 via tapered neck 308. FIG. 16B depicts a top view of the connector body 310, which contains grooved cavity 306 with five channels lining the cavity 306. FIG. 16C illustrates a sectional view of the connector. When the push fire sprinkler head is activated by a fire, water flows through the grooved channels 306 and the smooth channel 102 to the push fire sprinkler head.

The valve stem spacer is depicted in FIG. 17A and 17B. FIG. 17A shows a top view of the valve stem spacer 316 and FIG. 17B depicts a side view of the valve stem spacer 316. The top of the valve stem spacer 316 comprises two half-moon shaped channels 318 through which water or fire suppressant flow from the grooved cavity 306 to be sprayed upon a fire. The valve stem spacer also contains at least one central, circular opening 322 that positions the “T” shaped supply valve stem pin 312 when the push fire sprinkler device is in the ready position. FIG. 17B illustrates a side view of the valve stem spacer 316. The central channel 322 is positioned at the top of the spacer 316. The valve stem spacer 316 fits within the fire sprinkler head body 302 (shown in FIG. 15A and 15B). The supply valve stem comprises a pin 312 and a head 324 as depicted in FIG. 18.

Having thus described our invention, and the manner of its use, it should be apparent to one of average skill in the arts that incidental changes may be made thereto that fairly fall within the scope of the following appended claims, wherein we claim:

The inventors hereby claim:

1) A fire sprinkler system with rapid water or fire suppressant termination comprising:
a connector connecting to the water supply outlet of a water sprinkler system;
a fire sprinkler connected to said connector;
a shutoff mechanism integrated into said connector or said fire sprinkler head, said shutoff mechanism terminating a flow of said water or fire suppressant when said fire sprinkler is rotated relative to said fitting,
wherein said shutoff mechanism includes an exterior region configured to be engageable by hand or by a tool simulating an action of a hand, whereupon said fire sprinkler is simultaneously rotated relative to said connector and said flow of water or fire suppressant is terminated.

2) The fire sprinkler of claim 1, wherein the fire sprinkler contains a heat-sensitive member that is thermodynamically responsive to at least one of heat, smoke, infrared radiation and ultraviolet radiation emitted by a heat source, and deforms or dissolves when heated to its tolerance temperature.

3) The fire sprinkler of claim 1, wherein a deflector shield disperses water or another fire retardant in a reasonably uniform shower pattern to create more effective fire suppression.

4) The fire sprinkler of claim 1, wherein the sprinkler is installed as a pendent sprinkler below the supply pipe.

5) The fire sprinkler of claim 1, wherein the sprinkler assembly is of a sufficiently short length to allow the sprinkler to fit into a standard sprinkler head recession space.

6) The fire sprinkler of claim 1, wherein the sprinkler is installed as one of a vertical sprinkler above the supply pipe, a lateral sprinkler, or any other angle to the supply pipe necessitated by conditions.

7) A method of terminating the flow of water or fire suppressant through a fire sprinkler including engaging the hand of a user to rotate a fire sprinkler head such that said rotation activates an automatic shutoff mechanism terminating the flow of fire suppressant through the fire sprinkler.

8) A fire sprinkler system with rapid water or fire suppressant termination comprising:
a connector connecting to the water supply outlet of a water sprinkler system;
a fire sprinkler connected to said connector;
a shutoff mechanism integrated into said connector or said fire sprinkler head, said shutoff mechanism terminating a flow of said water or fire suppressant when said connector and said fire sprinkler are separated,
wherein said shutoff mechanism includes an exterior region configured to be engageable by hand or by a tool simulating an action of a hand, whereupon said fire sprinkler is simultaneously disconnected from said connector and said flow of water or fire suppressant from said distribution line is terminated.

9) The fire sprinkler of claim 8, wherein the cutoff valve requires a user to push upon said fire sprinkler or an arm, protrusion, flange, knob, extension, or brim extending from said fire sprinkler in order to terminate the flow of water or fire suppressant through the fire sprinkler.

10) The fire sprinkler of claim 8, wherein the cutoff valve requires a user to pull upon the fire sprinkler or an arm, protrusion, flange, knob, extension, or brim extending from said fire sprinkler in order to terminate the flow of water or fire suppressant through the fire sprinkler.

11) The fire sprinkler of claim 8, wherein the sprinkler contains a heat-sensitive member that is thermodynamically responsive to at least one of heat, smoke, infrared radiation and ultraviolet radiation emitted by a heat source, and deforms or dissolves when heated to its tolerance temperature.

12) The fire sprinkler of claim 8, wherein a deflector shield disperses water or another fire retardant in a reasonably uniform shower pattern to create more effective fire suppression.

13) The fire sprinkler of claim 8, wherein the sprinkler is installed as a pendent sprinkler below the supply pipe.

14) The fire sprinkler of claim 8, wherein the sprinkler assembly is of a sufficiently short length to allow the sprinkler to fit into a standard sprinkler head recession space.

15) The fire sprinkler of claim 8, wherein the sprinkler is installed as one of a vertical sprinkler above the supply pipe, a lateral sprinkler, or any other angle to the supply pipe necessitated by conditions.

16) (canceled)
